(19) United States
(12) Patent Application Publication
(10) Pub. No.: US 2005/0272503 A1
(43) Pub. Date: Dec. 8, 2005

(54) Mobile electronic devices for video gaming and related gaming devices and methods

(76) Inventor: Johan Thoresson, Lund (SE)

Correspondence Address: MYERS BIGEL SIBLEY & SAJOVEC, PO BOX 37428, RALEIGH, NC, 27627, US

(21) Appl. No.: 10/860,294

(22) Filed: Jun. 3, 2004

(51) Int. Cl. A63F 13/00

(52) U.S. Cl. 463/40

(57) ABSTRACT

A mobile electronic device may include a video display, a user interface, a wireless transmitter, and a controller. The video display may be configured to provide video information to a user of the mobile electronic device, the user interface may be configured to accept user input at the mobile electronic device, and the controller may be coupled to the video display, to the user interface, and to the wireless transmitter. The controller may be configured to run a video game responsive to user input accepted at the user interface, to generate personal gaming video information for the video game for display on the video display of the mobile gaming device, and to generate public gaming video information for the video game for transmission from the wireless transmitter and display on a public display. Moreover, the personal gaming video information and the public gaming video information may be different. Related gaming devices and methods are also discussed.

### FIELD OF THE INVENTION

The present invention relates to the field of electronics and more particularly to video gaming and related devices and methods.

### BACKGROUND

A conventional computer video game may be run on a general purpose gaming device such as a personal computer or a dedicated gaming device (such as a Sony PlayStation, a Micro Soft Xbox, or a Nintendo GameCube). When running a computer video game on a personal computer, the graphic elements of the video game may be displayed on a monitor coupled with the personal computer. When running a computer video game on a dedicated gaming device, the graphic elements of the video game may be displayed on a television coupled with the dedicated gaming device. One or more players may play a video game using either general purpose or dedicated gaming device, with all players viewing the same information on the monitor or television.

In addition, mobile gaming may be provided on a hand-held electronic device such as a dedicated mobile gaming device (such as a Nintendo Game Boy), a radiotelephone, and/or a personal digital assistant. A display of a hand-held electronic device, however, may be limited in size so that it may be difficult for multiple players to play a same game using the same hand-held electronic device.

### SUMMARY

According to embodiments of the present invention, a mobile electronic device may include a video display, a user interface, a wireless transmitter, and a controller. The video display may be configured to provide video information to a user of the mobile electronic device, the user interface may be configured to accept user input at the mobile electronic device, and the controller may be coupled to the video display, to the user interface, and to the wireless transmitter. More particularly, the controller may be configured to run a video game responsive to user input accepted at the user interface, and to generate personal gaming video information for the video game for display on the video display of the mobile gaming device. The controller may also be configured to generate public gaming video information for the video game for transmission from the wireless transmitter and display on a public display, and the personal gaming video information and the public gaming video information may be different. The wireless transmitter may be a short range transmitter, such as a BlueTooth and/or WLAN transmitter.

The mobile electronic device may also include a wireless receiver with the controller being further configured to receive gaming inputs from a remote mobile electronic device through the wireless receiver and to run the video game responsive to the user input accepted at the user interface and responsive to the gaming inputs received at the wireless receiver from the remote mobile electronic device. The wireless receiver may be a short range receiver such as a BlueTooth and/or WLAN receiver. In addition, a client/server relationship may exist between the controller of the mobile electronic device and a controller of the remote mobile electronic device so that the controller of the mobile electronic device is configured to act as a gaming server and the controller of the remote mobile electronic device is configured to act as a gaming client. In addition or in an alternative, operations of running the video game may be distributed between the controller of the mobile electronic device and a controller of the remote mobile electronic device.

The mobile electronic device may be a dedicated gaming device, or the mobile electronic device may provide additional functionalities. For example, the mobile electronic deice may include a radiotelephone transceiver, and the controller may be further configured to provides radiotelephone communications using the radiotelephone transceiver. Moreover, the public display may be one of a television, and/or a computer monitor.

According to additional embodiments of the present invention, a mobile electronic device may include a video display, a user interface, a wireless transceiver, and a controller. The video display may be configured to provide video information to a user of the mobile electronic device, the user interface may be configured to accept user input at the mobile electronic device, and the controller may be coupled to the video display, to the user interface, and to the wireless transceiver. More particularly, the controller may be configured to transmit gaming inputs to a remote gaming device using the wireless transceiver responsive to user input accepted at the user interface, and the controller may be configured to generate gaming video information for display on the video display.

The controller may generate the gaming video information responsive to video information received from the remote gaming device using the wireless transceiver. Moreover, the wireless transceiver may include a short range transceiver such as a BlueTooth and/or WLAN transceiver. Moreover, a client/server relationship may exist between the gaming device and the controller so that the gaming device is configured to act as a gaming server running the video game and the controller of the mobile electronic device is configured to act as a gaming client. In addition or in an alternative, operations of running the video game may be distributed between the controller of the mobile electronic device and a controller of the remote gaming device.

The remote gaming device may be a dedicated gaming device, a personal computer, and/or a laptop computer. Moreover, the remote gaming device may be configured to generate public gaming video information on a remote display, and the public gaming video information and the gaming video information for display on the video display of the mobile electronic device may be different. More particularly, the remote display may be one of a television, and/or a computer monitor.

The remote gaming device may be a remote mobile electronic device. In addition, the mobile electronic device may include a radiotelephone transceiver, and the controller may provide radiotelephone communications using the radiotelephone transceiver.

According to still additional embodiments of the present invention, a gaming device may include a controller configured to run a video game in cooperation with at least one mobile electronic device having a display thereon. More particularly, the controller may be configured to run the video game responsive to user input received from the mobile electronic device over a wireless interface, to generate public gaming video information for display on a public display, and to generate personal gaming video information for the video game for display on the display of the mobile electronic device. Moreover, the public gaming video information and the personal gaming video information may be different.

The user input from the mobile electronic device may be received over a short range wireless interface such as a BlueTooth and/or WLAN wireless interface. Moreover, the controller may be configured to run the video game responsive to user input received from a plurality of mobile electronic devices over the wireless interface, and the personal gaming video information may be transmitted to the mobile electronic device over the wireless interface. In addition, the public display may be one of a television, and/or a computer monitor.

According to yet additional embodiments of the present invention, methods of gaming on a mobile electronic device may include running a video game on a controller of the mobile electronic device responsive to user input accepted at a user interface of the mobile electronic device. Personal gaming video information for the video game may be generated for display on a video display of the mobile gaming device. In addition, public gaming video information for the video game may be generated, and the public gaming video information may be transmitted over a wireless interface for display on a public display. Moreover, the personal gaming video information and the public gaming video information may be different.

The wireless transmitter may include a short range transmitter such as a BlueTooth and/or WLAN transmitter. Gaming inputs may be received from a remote mobile electronic device through a wireless receiver. Moreover, running the video game may include running the video game responsive to user input accepted at the user interface of the mobile electronic device and responsive to the gaming inputs received through the wireless receiver from the remote mobile electronic device.

According to more embodiments of the present invention, methods of gaming on a mobile electronic device may include transmitting gaming inputs from the mobile electronic device to a remote gaming device over a wireless interface responsive to user input accepted at a user interface of the mobile electronic device. In addition, gaming video information may be generated for display on a video display of the mobile electronic device. More particularly, generating gaming video information may include generating gaming video information responsive to video information received over the wireless interface from the remote gaming device.

The wireless interface may be a short range wireless interface such as a BlueTooth and/or WLAN wireless interface. The remote gaming device may be a gaming console, a personal computer, and/or a laptop computer, and the remote gaming device may be a remote mobile electronic device.

According to still more embodiments of the present invention, methods of video gaming may include running the video game responsive to user input received from a mobile electronic device over a wireless interface. Public gaming video information may be generated for the video game for display on a public display, and personal gaming video information may be generated for the video game for display on a display of the mobile electronic device. Moreover, the public gaming video information and the personal gaming video information may be different. In addition, running the video game may include running the video game responsive to user input received from a plurality of mobile electronic devices over the wireless interface.

### BRIEF DESCRIPTION OF THE DRAWINGS

FIG. 1 is a block diagram illustrating mobile electronic devices, wireless transceivers, and methods according to embodiments of the present invention.

FIG. 2 is a block diagram illustrating mobile electronic devices, wireless transceivers, and methods according to additional embodiments of the present invention.

### DETAILED DESCRIPTION

The present invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As will be appreciated by those of skill in the art, the present invention may be embodied as methods or devices. Accordingly, the present invention may take the form of a hardware embodiment, a software embodiment or an embodiment combining software and hardware aspects. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items.

It will also be understood that although the terms first, second, etc. are used herein to describe various elements, these elements should not be limited by these terms. These terms are only used to distinguish one element or embodiment from another element or embodiment. Thus, a first element or embodiment could be termed a second element or embodiment, and similarly, a second element or embodiment may be termed a first element or embodiment without departing from the teachings of the present invention.

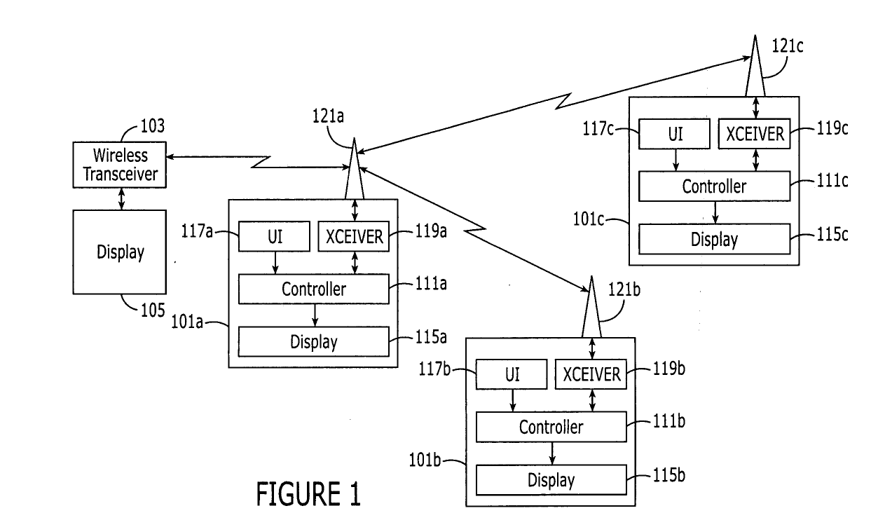

As shown in FIG. 1, a plurality of players may participate in a video game using a respective plurality of mobile electronic devices 101a-c, a wireless transceiver 103, and a public display 105. Each of the mobile electronic devices 101a-c may include a controller 111a-c, a display 115a-c, a user interface 117a-c, a transceiver 119a-c (xceiver), and an antenna 121a-c. More particularly, public video gaming information for the video game may be made available to all players on the public display 105, and personal gaming video information may be made available to individual players on displays 115a-c of the respective mobile electronic devices 101a-c. One or more of the mobile electronic devices 101a-c may be a hand-held electronic device such as a radiotelephone, a personal digital assistant, and/or a dedicated mobile gaming device.

According to embodiments of the present invention, the plurality of mobile electronic devices 101a-c may be networked wirelessly so that each mobile electronic device 101a-c may support participation of a different player in a same game. Each player may thus be provided with personal gaming video information on their respective display 115a-c, and public gaming video information may be provided to all players on the public display 105. The personal gaming video information for each player may be unique, and the public gaming video information may be different than the personal gaming video information provided for any of the players.

In a video poker game, for example, each player may see the cards in their hand (i.e. personal gaming video information) on the display 115 of their respective mobile electronic device 101; and the bets, antes, and/or other information used by all players (i.e. public gaming video information) may be seen by all players on the public display 105. In another example, two players may play an American style video football game using respective mobile electronic devices 101a-b. In the example of a football game, the players may secretly enter respective offensive and defensive plays (i.e. personal gaming video information) into their respective mobile electronic devices before each play (with the plays being shown on displays 115 of the respective mobile electronic devices), and the execution of each play (i.e. public information) may be shown on the public display 105.

According to particular embodiments of the present invention illustrated in FIG. 1, a mobile electronic device 101 may accept user input through a user interface 117 such as a keypad, a dial, a directional key(s), a joy stick, a touch sensitive screen, and/or a tracking device, and the controller 111 may control operation of the mobile electronic device 101 responsive to user input accepted through the user interface 117. Moreover, information can be transmitted from and/or received by the controller 111 over a wireless interface using the transceiver 119 and antenna 121. For example, the transceiver 119 may include a short range transmitter and receiver, such as BlueTooth transmitter and receiver and/or a wireless local are network (WLAN) transmitter and receiver according to one of the 802.11 standards, so that a wireless interface may be provided between the mobile electronic devices 101a-c and/or the wireless transceiver 103. The BlueTooth protocol is discussed, for example, by Sailesh Rathi in the reference entitled “Blue Tooth Protocol Architecture” from Dedicated Systems Magazine, 2000 Q4, pages 28-33, the disclosure of which is hereby incorporated herein in its entirety by reference.

In addition or in an alternative, a wireless interface may be provided between the mobile electronic devices 101a-c and/or the wireless transceiver 103 using a long range transmitter and receiver such as a cellular radiotelephone transmitter and receiver. When using a long range transmitter and receiver, players in different locations may play a same game with public gaming information being broadcast as television programming. For example, the wireless transceiver 103 may be located at a television broadcasting station and the display 105 may be a plurality of separately located televisions. In an alternative, the wireless transceiver 103, the display 105, and the mobile electronic devices 101a-c may be co-located with long range transmitters and receivers being used to avoid the addition of separate short range transmitters and receivers.

In addition, the transceiver 119 may also include a long range transmitter and/or receiver, for example, to provide radiotelephone communications. The mobile electronic device 101 may thus provide radiotelephone and/or other operations in addition to video gaming operations. In addition or in an alternative, the mobile electronic device 101 may provide functionality of a personal digital assistant. In addition to gaming operations, for example, the mobile electronic device may provide an electronic address book, an electronic calendar, provide music recording/playback, a radiotelephone, an internet browser, an e-mail transmitter/receiver/reader, text messaging, paging, and/or other functionalities.

As shown in FIG. 1, the controller 111a of the mobile electronic device 101a may be configured to run a video game responsive to user input accepted through the user interface 117a of the mobile electronic device 101a. The controller 111a may be further configured to run the video game responsive to user input from other players accepted through user interfaces 117b and/or 117c of other mobile electronic devices 101b and/or 101c. User inputs accepted at user interfaces 117b-c may be processed by respective controllers 111b-c and transmitted over a wireless interface using respective transceivers 119b-c and antennas 121b-c. Moreover, the controller 111a may be configured to generate personal gaming video information for displays 115a-c of each of the mobile electronic devices 101a-c and the personal gaming video information for each mobile electronic device may be different.

More particularly, the personal gaming video information for the mobile electronic device 101a may be provided by the controller 111a directly to the display 115a, and the personal gaming video information for the mobile electronic devices 101b-c may be transmitted over the wireless interface using transceiver 119a and antenna 121a and received using antennas 121b-c and transceivers 119b-c. The controllers 111b-c can then process the received personal gaming video information for display on respective displays 115b-c. In an alternative, personal video gaming information for displays 115b-c of mobile electronic devices 101b-c may be generated by respective controllers 111b-c responsive to user inputs accepted at user interfaces 117b-c. In yet another alternative, personal gaming video information for displays 115b-c may be a combination of information received over the wireless interface and information accepted through respective user interfaces 117b-c.

For example, a client/server relationship may exist between the controllers 111a-c of mobile electronic devices 101 a-c so that the controller 111a of the mobile electronic device 111a running the video game is configured to act as a gaming server, and so that the controllers 111b and/or 111c of the mobile electronic devices 101b and/or 101c are configured to act as gaming clients. In an alternative, tasks of running the video game may be distributed among the controllers 111a-c so that a peer-to-peer relationship exists between the controllers 111a-c. Accordingly, the mobile electronic devices 101a-c may receive all user inputs for the game so that a separate user input, such as a separate control pad or joy stick, is not required.

In addition, the controller 111a of the mobile electronic device 101a running the video game may be configured to generate public gaming video information for the video game, and the public gaming video information may be transmitted by the transceiver 119a and the antenna 121a to the wireless transceiver 103 for display on the public display 105. While shown as separate blocks, functionality of the wireless transceiver 103 and the public display 105 may be incorporated in a single unit. For example, the wireless transceiver 103 may be a BlueTooth and/or WLAN transceiver that is plugged into a video input on a television serving as the public display 105. In an alternative, the wireless transceiver 103 may include a public display therein. The display of video information from a mobile electronic device on a remote video display is discussed, for example, in U.S. patent application Ser. No. 10/655,422 filed Sep. 4, 2003 and assigned to the assignee of the present invention. The disclosure of U.S. patent application Ser. No. 10/655,422 is hereby incorporated herein in its entirety by reference. The public display 105, for example, may be a television and/or a computer monitor.

Moreover, wireless links between the mobile electronic device 101a and the mobile electronic devices 101b and/or 101c, and between the mobile electronic device 101a and the wireless transceiver 103 may be provided using a short range wireless protocol such as the BlueTooth protocol and/or a WLAN protocol. In addition or in an alternative, wireless links between the mobile electronic device 101a and mobile electronic devices 101b and/or 101a, and between the mobile electronic device 101a and the wireless transceiver 103 may be provided using a long range transmitter and receiver such as a cellular radiotelephone transmitter and receiver. In embodiments of FIG. 1, all links between gaming devices are shown as being provided through the mobile electronic device 101a running the video game. In an alternative, operations of running the video game may be distributed between the mobile electronic devices 101a-c, and/or wireless links may be provided between mobile electronic devices 101b-c and/or between mobile electronic devices 101b-c and the wireless transceiver 103.

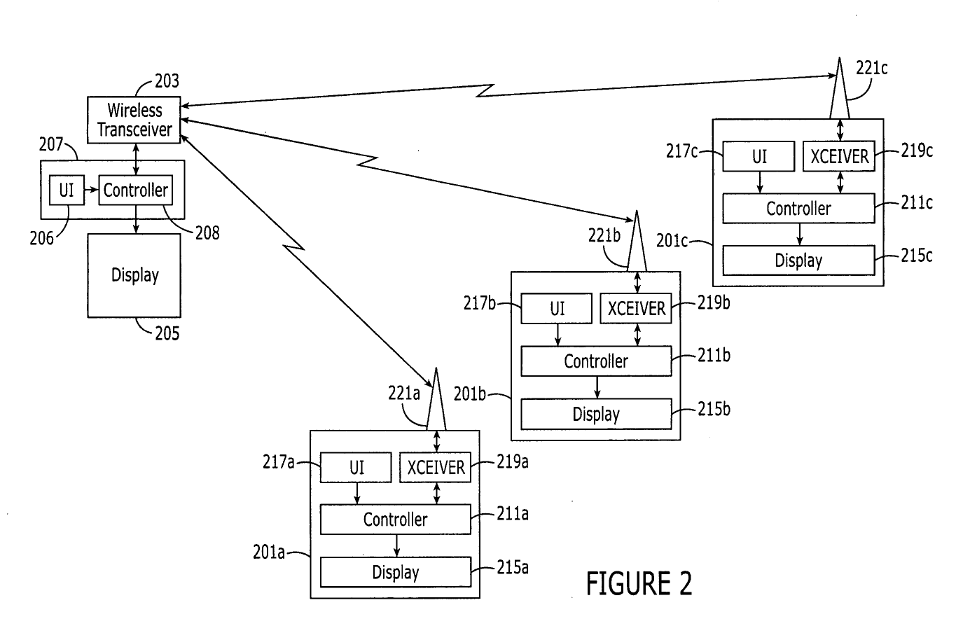

As shown in FIG. 2, a plurality of players may participate in a video game using a respective plurality of mobile electronic devices 201a-c, a gaming device 207, a wireless transceiver 203, and a public display 205. Each of the mobile electronic devices 201a-c may include a controller 211a-c, a display 215a-c, a user interface 217a-c, a transceiver 219a-c, and an antenna 221a-c. More particularly, public video gaming information for the video game may be made available to all players on the public display 205, and personal gaming video information may be made available to individual players on displays 215a-c of the respective mobile electronic devices 201a-c. One or more of the mobile electronic devices 201a-c may be a hand-held electronic device such as a radiotelephone, a personal digital assistant, and/or a dedicated mobile gaming device.

According to embodiments of the present invention, the plurality of mobile electronic devices 201a-c may be networked wirelessly with the gaming device 207 through the wireless transceiver 203 so that each mobile electronic device 201a-c may support participation of a different player in a same game. Each player may thus be provided with personal gaming video information on their respective display 215a-c, and public gaming video information may be provided to all players on the public display 205. The personal gaming video information for each player may be unique, and the public gaming video information may be different than the personal gaming video information provided for any of the players.

In a video poker game, for example, each player may see the cards in their hand (i.e. personal gaming video information) on the display 215 of their respective mobile electronic device 201; and the bets, antes, and/or other information used by all players (i.e. public gaming video information) may be seen by all players on the public display 205. In another example, two players may play an American style video football game using respective mobile electronic devices 201a-b. In the example of a football game, the players may secretly enter respective offensive and defensive plays (i.e. personal gaming video information) into their respective mobile electronic devices before each play (with the plays being shown on displays 215 of the respective mobile electronic devices), and the execution of each play (i.e. public information) maybe shown on the public display 205.

According to particular embodiments of the present invention illustrated in FIG. 2, a mobile electronic device 201 may accept user input through a user interface 217 such as a keypad, a dial, a directional key(s), a joy stick, a touch sensitive screen, and/or a tracking device, and the controller 211 may control operation of the mobile electronic device 201 responsive to user input accepted through the user interface 217. Moreover, information can be transmitted from and/or received by the controller 211 over a wireless interface using the transceiver 219 and antenna 221. For example, the transceiver 219 may include a short range transmitter and receiver, such as BlueTooth transmitter and receiver and/or a WLAN transmitter and receiver, so that a wireless interface may be provided between each of the mobile electronic devices 201a-c and the wireless transceiver 203.

In addition or in an alternative, the transceiver 219 may include a short range transmitter and receiver such as a cellular radiotelephone transmitter and receiver. When using a long range transmitter and receiver, players in different locations may play a same game with public gaming information being broadcast as television programming. For example, the wireless transceiver 203 and/or the gaming device 207 may be located at a television broadcasting station and the display 205 may be a plurality of separately located televisions. In an alternative, the wireless transceiver 203, the display 205, and the mobile electronic devices 201a-c may be co-located with long range transmitters and receivers being used to avoid the addition of separate short range transmitters.

In addition, the transceiver 219 may also include a long range transmitter and/or receiver, for example, to provide radiotelephone communications. The mobile electronic device 201 may thus provide radiotelephone and/or other operations in addition to video gaming operations. In addition or in an alternative, the mobile electronic device 201 may provide functionality of a personal digital assistant. In addition to gaming operations, for example, the mobile electronic device may provide an electronic address book, an electronic calendar, provide music recording/playback, a radiotelephone, an internet browser, an e-mail transmitter/receiver/reader, text messaging, paging, and/or other functionalities.

As shown in FIG. 2, the gaming device 207 may include a controller 208 and a user interface 206 configured to accept user input at the gaming device 207. The controller 208 may be configured to run a video game in cooperation with one or more of the mobile electronic devices 201a-c responsive to user input accepted though user interface(s) 217a-c of the mobile electronic device(s) 201a-c and received from the mobile electronic device(s) 201a-c over a wireless interface using wireless transceiver 203. User inputs accepted at user interfaces 217a-c may be processed by respective controllers 211a-c and transmitted over a wireless interface using respective transceivers 219a-c and antennas 221a-c.

More particularly, the controller 208 may generate public gaming video information for the video game for display on the public display 205, and the controller 208 may generate personal gaming video information for the video game for display on a display(s) 215a-c of at least one of the mobile electronic devices 201a-c. As discussed above, the public gaming video information is different than the personal gaming video information.

The personal gaming video information for the mobile electronic devices 201a-c may be transmitted over the wireless interface using wireless transceiver 203 and received using antennas 221a-c and transceivers 219a-c. The controllers 211a-c can then process the received personal gaming video information for display on respective displays 215a-c. In an alternative, personal video gaming information for displays 215a-c of mobile electronic devices 201a-c may be generated by respective controllers 211a-c responsive to user inputs accepted at user interfaces 217a-c. In yet another alternative, personal gaming video information for displays 215a-c may be a combination of information received over the wireless interface and information accepted through respective user interfaces 217a-c.

For example, a client/server relationship may exist between the controller 208 of the gaming device 207 and the controllers 211a-c of mobile electronic devices 201a-c so that the controller 208 of the gaming device 207 running the video game is configured to act as a gaming server, and so that the controllers 211a, 211b, and/or 211c of the mobile electronic devices 201a, 201b, and/or 201c are configured to act as gaming clients. In an alternative, tasks of running the video game may be distributed among the controller 208 and the controllers 211a-c so that a peer-to-peer relationship exists between the controllers 208 and 211a-c. Accordingly, the mobile electronic devices 201a-c may receive all user inputs for the game so that a separate user input, such as a separate control pad and/or joy stick, is not required.

In addition, the controller 208 of the gaming device 207 running the video game may be configured to generate public gaming video information for the video game, and the public gaming video information may be provided for public gaming use on the public display 205. For example, the wireless transceiver 203 may be a BlueTooth and/or WLAN transceiver. While shown as separate blocks, functionality of the wireless transceiver 203, the gaming device 208, and/or the public display 205 may be combined in a single unit. The public display 205, for example, may be a television and/or a computer monitor. Moreover, a user interface 206 may be provided on the gaming device 207 so that conventional video games using only public video gaming information (and not personal gaming video information) may be played without using separate mobile electronic devices 201a-c.

Moreover, wireless links between the wireless transceiver 203 and the mobile electronic devices 201a, 201b, and/or 201c may be provided using a short range wireless protocol such as the BlueTooth protocol and/or WLAN protocol. In addition or in an alternative, wireless links between wireless transceiver 203 and the mobile electronic devices 201a, 201b, and/or 201c may be provided using a long range protocol such as a cellular radiotelephone protocol. In embodiments of FIG. 2, all links to gaming devices are shown as being provided through the wireless transceiver 203 and/or gaming device 207 running the game. In an alternative, operations of running the video game may be distributed between the gaming device 207 and the mobile electronic devices 201a-c, and/or wireless links may be provided between mobile electronic devices 201a-c.

By incorporating mobile electronic devices including separate personal displays in a gaming environment including a larger public display, a complexity of play may be increased because different video information may be provided to different players participating in the same game. By using a gaming device (separate from mobile electronic devices) as a gaming server to run a video game, a relatively high degree of processing power may be used to run the video game(s).

In the drawings and specification, there have been disclosed typical preferred embodiments of the invention and, although specific terms are employed, they are used in a generic and descriptive sense only and not for purposes of limitation, the scope of the invention being set forth in the following claims. As used herein, the term “comprising” or “comprises” is open-ended, and includes one or more stated elements, steps, and/or functions. More particularly, it should be emphasized that the term “comprises/comprising” when used in this specification is taken to specify the presence of stated features, integers, steps or components but does not preclude the presence or addition of one or more other features, integers, steps, components or groups thereof.

1. A mobile electronic device comprising:
a video display configured to provide video information to a user of the mobile electronic device;
a user interface configured to accept user input at the mobile electronic device;
a wireless transmitter; and
a controller coupled to the video display, to the user interface, and to the wireless transmitter, the controller being configured to run a video game responsive to user input accepted at the user interface, the controller being configured to generate personal gaming video information for the video game for display on the video display of the mobile gaming device, and the controller being configured to generate public gaming video information for the video game for transmission from the wireless transmitter and display on a public display, wherein the personal gaming video information and the public gaming video information are different.

2. A mobile electronic device according to claim 1 wherein the wireless transmitter comprises a short range transmitter.

3. A mobile electronic device according to claim 2 wherein the short range wireless transmitter comprises a BlueTooth and/or WLAN transmitter.

4. A mobile electronic device according to claim 1 further comprising:
a wireless receiver;
wherein the controller is further configured to receive gaming inputs from a remote mobile electronic device through the wireless receiver and wherein the controller is further configured to run the video game responsive to the user input accepted at the user interface and responsive to the gaming inputs received at the wireless receiver from the remote mobile electronic device.

5. A mobile electronic device according to claim 4 wherein the wireless receiver comprises a short range receiver.

6. A mobile electronic device according to claim 5 wherein the short range receiver comprises a BlueTooth and/or WLAN receiver.

7. A mobile electronic device according to claim 4 wherein a client/server relationship exists between the controller of the mobile electronic device and a controller of the remote mobile electronic device so that the controller of the mobile electronic device is configured to act as a gaming server and the controller of the remote mobile electronic device is configured to act as a gaming client.

8. A mobile electronic device according to claim 4 wherein operations of running the video game are distributed between the controller of the mobile electronic device and a controller of the remote mobile electronic device.

9. A mobile electronic device according to claim 1 further comprising:
a radiotelephone transceiver;
wherein the controller provides radiotelephone communications using the radiotelephone transceiver.

10. A mobile electronic device according to claim 1 wherein the public display comprises one of a television, and/or a computer monitor.

11. A mobile electronic device comprising:
a video display configured to provide video information to a user of the mobile electronic device;
a user interface configured to accept user input at the mobile electronic device;
a wireless transceiver;
a controller coupled to the video display, to the user interface, and to the wireless transceiver, the controller being configured to transmit gaming inputs to a remote gaming device using the wireless transceiver responsive to user input accepted at the user interface, and the controller being configured to generate gaming video information for display on the video display.

12. A mobile electronic device according to claim 11 wherein the controller generates the gaming video information responsive to video information received from the remote gaming device using the wireless transceiver.

13. A mobile electronic device according to claim 11 wherein the wireless transceiver comprises a short range transceiver.

14. A mobile electronic device according to claim 13 wherein the short range wireless transceiver comprises a BlueTooth and/or WLAN transceiver.

15. A mobile electronic device according to claim 11 wherein a client/server relationship exists between the gaming device and the controller so that the gaming device is configured to act as a gaming server running the video game and so that the controller of the mobile electronic device is configured to act as a gaming client.

16. A mobile electronic device according to claim 11 wherein operations of running the video game are distributed between the controller of the mobile electronic device and a controller of the remote gaming device.

17. A mobile electronic device according to claim 11 wherein the remote gaming device comprises a dedicated gaming device, a personal computer, and/or a laptop computer.

18. A mobile electronic device according to claim 11 wherein the remote gaming device is configured to generate public gaming video information on a remote display, wherein the public gaming video information and the gaming video information for display on the video display of the mobile electronic device are different.

19. A mobile electronic device according to claim 18 wherein the remote display comprises one of a television, and/or a computer monitor.

20. A mobile electronic device according to claim 11 wherein the remote gaming device comprises a remote mobile electronic device.

21. A mobile electronic device according to claim 11 further comprising:
a radiotelephone transceiver;
wherein the controller provides radiotelephone communications using the radiotelephone transceiver.

22. A gaming device comprising:
a controller configured to run a video game in cooperation with at least one mobile electronic device having a display thereon, the controller being configured to run the video game responsive to user input received from the mobile electronic device over a wireless interface, the controller being configured to generate public gaming video information for display on a public display, and the controller being configured to generate personal gaming video information for the video game for display on the display of the mobile electronic device, wherein the public gaming video information and the personal gaming video information are different.

23. A gaming device according to claim 22 wherein the user input from the mobile electronic device is received over a short range wireless interface.

24. A gaming device according to claim 23 wherein the short range wireless interface comprises a BlueTooth and/or WLAN wireless interface.

25. A gaming device according to claim 22 wherein the controller is configured to run the video game responsive to user input received from a plurality of mobile electronic devices over the wireless interface.

26. A gaming device according to claim 22 wherein the personal gaming video information is transmitted to the mobile electronic device over the wireless interface.

27. A gaming device according to claim 22 wherein the public display comprises one of a television, and/or a computer monitor.

28. A method of gaming on a mobile electronic device, the method comprising:
running a video game on a controller of the mobile electronic device responsive to user input accepted at a user interface of the mobile electronic device,
generating personal gaming video information for the video game for display on a video display of the mobile gaming device;
generating public gaming video information for the video game; and
transmitting the public gaming video information over a wireless interface for display on a public display, wherein the personal gaming video information and the public gaming video information are different.

29. A method according to claim 28 further comprising:
receiving gaming inputs from a remote mobile electronic device through a wireless receiver;
wherein running the video game comprises running the video game responsive to user input accepted at the user interface of the mobile electronic device and responsive to the gaming inputs received through the wireless receiver from the remote mobile electronic device.

30. A method of gaming on a mobile electronic device, the method comprising:
transmitting gaming inputs from the mobile electronic device to a remote gaming device over a wireless interface responsive to user input accepted at a user interface of the mobile electronic device; and
generating gaming video information for display on a video display of the mobile electronic device

31. A method according to claim 30 wherein generating gaming video information comprise generating gaming video information responsive to video information received over the wireless interface from the remote gaming device.

32. A method of video gaming, the method comprising:
running the video game responsive to user input received from a mobile electronic device over a wireless interface;
generating public gaming video information for the video game for display on a public display; and
generating personal gaming video information for the video game for display on a display of the mobile electronic device, wherein the public gaming video information and the personal gaming video information are different.

33. A method according to claim 32 wherein running the video game comprises running the video game responsive to user input received from a plurality of mobile electronic devices over the wireless interface.
